(19) United States
(12) Patent Application Publication
(10) Pub. No.: US 2026/0194847 A1
(43) Pub. Date: Jul. 9, 2026

(54) IMAGE FORMING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: KENICHIROU HARUTA, Chiba (JP)

(21) Appl. No.: 19/417,911

(22) Filed: Dec. 12, 2025

(30) Foreign Application Priority Data
Jan. 7, 2025 (JP) 2025-002370

(51) Int. Cl. G03G 15/00; G03G 15/01; G03G 15/02

(52) U.S. Cl. CPC G03G 15/5033; G03G 15/0189; G03G 15/02; G03G 2215/00063

(57) ABSTRACT

An image forming apparatus in which image quality deterioration does not occur even when an image blur amount varies due to various factors by executing an appropriate correction process. The image forming apparatus is capable of forming, on a sheet, an image based on image data. The image forming apparatus includes a memory device that stores a set of instructions, and at least one processor that executes the set of instructions to determine correction coefficient based on a grid potential of a grid electrode of a charger provided for a photosensitive drum of the image forming apparatus, and execute a correction process of a frequency characteristic of the image data based on the determined correction coefficient.

### BACKGROUND

### Field of the Technology

The aspect of the embodiments relates to an image forming apparatus, a control method therefor, and a storage medium storing a control program therefor.

### Description of the Related Art

In conventional electrophotographic image forming apparatuses, such as a copying machine and a multifunction machine, an electrostatic latent image is formed by performing selective exposure based on image data of an input original on a uniformly charged photosensitive member. Then, in order to visualize the electrostatic latent image, the electrostatic latent image is developed with toner to form a toner image on the photosensitive member. Further, the toner image formed on the photosensitive member is transferred to a recording sheet, and the toner image on the recording sheet after the transfer is fixed to the recording sheet by a fixing step, thereby forming an image.

In order to improve a reproducibility of an original in which characters, halftone dots, and photographs are mixed, there is a known image forming apparatus that classifies an original area into a character area, a halftone dot area, and a photograph area, and performs an optimal process on each area. For example, Japanese Patent Laid-Open No. 07-245709 (Counterpart of U.S. Pat. No. 5,886,797) discloses a technique for improving image quality of a paper output by performing an optimal MTF (Modulation Transfer Function) correction process on each area using an image area classification result obtained by analyzing an input image.

It is generally known that an image blur amount changes and the image quality deteriorates due to fluctuations in characteristics of a photosensitive member caused by temporal change, environmental change, and the like. Therefore, even if the MTF correction process is performed on the image area as disclosed in the above publication, there is a problem that appropriate correction cannot be performed when the characteristics of the photosensitive member change due to the environmental change or the like and the image blur amount changes. Further, an image may be deteriorated due to change of a screen ruling by switching of a screen pattern.

### SUMMARY

The present disclosure provides a mechanism in which image quality deterioration does not occur even when an image blur amount varies due to various factors by executing an appropriate correction process (MTF correction or the like).

Accordingly, an aspect of the embodiments provides an image forming apparatus capable of forming, on a sheet, an image based on image data. The image forming apparatus includes a memory device that stores a set of instructions, and at least one processor that executes the set of instructions to determine correction coefficient based on a grid potential of a grid electrode of a charger provided for a photosensitive drum of the image forming apparatus, and execute a correction process of a frequency characteristic of the image data based on the determined correction coefficient.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram illustrating an image processing system according to a first embodiment.

FIG. 2 is a sectional view schematically illustrating a configuration of an image forming apparatus according to the first embodiment.

FIG. 3 is a block diagram illustrating an image processor related to the first embodiment.

FIG. 4A and FIG. 4B are graphs explanatory illustrating a method of calculating a potential setting from environment information.

FIG. 5 is a block diagram illustrating an MTF correction unit.

FIG. 6 is a flowchart illustrating an MTF correction process.

FIG. 7 is a view describing a screen process.

FIG. 8A and FIG. 8B are views describing examples of filter coefficients.

FIG. 9A and FIG. 9B are graphs illustrating lookup tables of intensity coefficients.

FIG. 10 is a graph illustrating V-D characteristics representing relations between development contrast potential V and density D.

FIG. 11A, FIG. 11B, and FIG. 11C are graphs explanatory illustrating relations between screen ruling and contrast.

FIG. 12 is a view explanatory illustrating a difference in a dot size depending on a difference in the screen ruling.

FIG. 13 is a block diagram illustrating an MTF correction unit in a second embodiment.

FIG. 14 is a flowchart illustrating an MTF correction process in the second embodiment.

FIG. 15 is a view illustrating an example of a UI in a third embodiment.

FIG. 16 is a block diagram illustrating an MTF correction unit in the third embodiment.

FIG. 17 is a flowchart illustrating an MTF correction process in the third embodiment.

FIG. 18 is a view describing a coefficient calculation process in the third embodiment.

### DESCRIPTION OF THE EMBODIMENTS

Hereinafter, embodiments of the present invention will be described in detail with reference to the drawings. However, the configurations described in the following embodiments are merely examples, and the scope of the present invention is not limited by the configurations described in the embodiments. Further, a filter coefficient (C or B) described later can be regarded as a first correction coefficient of the entire MTF correction to correct frequency characteristics of image data. The present disclosure is characterized in that the first correction coefficient is calculated by appropriately modifying (selecting) a second correction coefficient (an intensity coefficient AA or AB) that contributes to the first correction coefficient.

A first embodiment will be described below. Image data in the first embodiment includes a plurality of pixels, and each pixel has a pixel value. For example, a pixel of image data in an RGB color space has luminance values of three components of R, G, and B, and a pixel of image data in a CMYK color space has density values of four components of C, M, Y, and K.

Attribute data in the present embodiment is associated with each pixel of image data, and the attribute data indicates an attribute type of an object to which each pixel belongs. Each pixel of image data is subjected to an image process corresponding to the associated attribute type. The attribute type is an image attribute, a graphic attribute, or a character attribute, for example. For example, pixels of the image attribute and the graphics attribute require smooth gradation, and thus a process that emphasizes gradation is applied. Pixels of the character attribute require visibility, and thus a process that emphasizes resolution is applied.

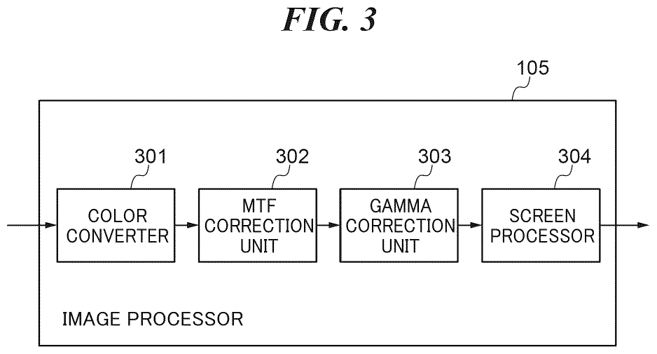

Therefore, when the attribute type of a pixel is the image attribute, a screen with a low screen ruling is set to a processing target of a screen processor 304 (see FIG. 3). Then, a gamma table corresponding to the screen with the low screen ruling is applied to a gamma correction unit 303 (see FIG. 3). On the other hand, when the attribute type of a pixel is the character attribute, a screen with a high screen ruling is set to a processing target of the screen processor 304. Then, a gamma table corresponding to the screen with the high screen ruling is applied to the gamma correction unit 303. The process by the screen processor 304 will be described later. The screen ruling indicates an accuracy (fineness) of printing and is the number of halftone dots arranged per one inch.

The attribute data is used to identify an object included in image data. There are a plurality of methods to generate the attribute data. For example, the attribute data is generated, when image data of a page is generated by rendering based on a PDL (Page Description Language) command, according to the type of the PDL command. For example, when the PDL command is for drawing a character, the attribute of pixels constituting an object generated by the PDL command becomes the character attribute (TEXT). The generated attribute data and the generated image data are associated with each other. In the present embodiment, an object constituted by pixels having the character attribute is treated as a character.

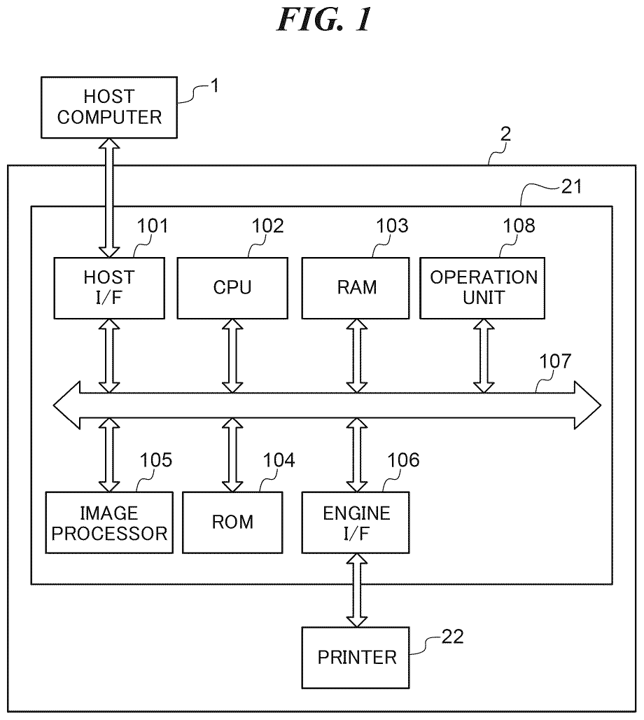

FIG. 1 is a configuration diagram illustrating an image processing system according to the present embodiment. The image processing system in FIG. 1 includes a host computer 1 and an image forming apparatus 2. The image forming apparatus 2 includes a controller 21 and a printer 22. The host computer 1 can be constructed by a computer such as a general PC or a WS (workstation). An image or a document created with a software application such as a printer driver (not shown) on the host computer 1 is transmitted to the image forming apparatus 2 via a network (Local Area Network or the like) as a PDL data. In the image forming apparatus 2, the controller 21 receives the transmitted PDL data.

The controller 21 is connected to the printer 22, receives PDL data from the host computer 1, converts the PDL data into a print data that can be processed by the printer 22, and outputs the print data to the printer 22. The printer 22 prints an image based on the print data output from the controller 21. The printer 22 of the present embodiment is provided with an electrophotographic print engine.

Next, the controller 21 will be described. The controller 21 includes a host I/F 101, a CPU 102, a RAM 103, a ROM 104, an image processor 105, an engine I/F 106 and an operation unit 108. These are connected via an internal bus 107 which is a system bus so as to be able to transmit and receive required information to and from each other.

The host I/F 101 is an interface for receiving PDL data transmitted from the host computer 1. The CPU 102 performs overall control of the image forming apparatus 2 using programs and data stored in the RAM 103 and the ROM 104, and executes a process described later performed by the controller 21. The RAM 103 has a work area used when the CPU 102 executes various processes. The ROM 104 stores program and data for causing the CPU 102 to execute various processes described later in a nonvolatile manner, and also stores a setting data of the controller 21 in a nonvolatile manner.

The image processor 105 executes an image process for printing on the PDL data received via the host I/F 101 according to the setting from the CPU 102 to generate print data that can be processed by the printer 22. In particular, the image processor 105 rasterizes the received PDL data to generate image data having a plurality of color components per pixel. The plurality of color components are independent color components in a color space such as RGB (red, green, blue). Image data has, for example, an 8-bit value (256 tones) for one color component for each pixel.

That is, image data is a multi-valued bitmap data including multi-valued pixels. In the rasterization described above, attribute data indicating an attribute of a pixel of image data for each pixel is also generated in addition to image data. The attribute data indicates a type of an object to which a pixel belongs, and is a value indicating an object type such as a character, a line, a graphic, an image, or a background. The image processor 105 generates print data by performing an image process such as a color conversion process from the RGB color space to the CMYK (cyan, magenta, yellow, black) color space and a screen process using the generated image data and the attribute data. The image processor 105 will be described in detail later.

The engine I/F 106 is an interface to transmit the print data generated by the image processor 105 to the printer 22. The operation unit 108 receives operations by a user and gives various instructions to the image forming apparatus 2 according to the operations. Specifically, various functions are selected or various operation instructions are given by the operations of the operation unit 108 by the user. The operation unit 108 includes a liquid crystal display having a touch panel on its surface, and various keys such as a start key, a stop key, and a numeric keypad. Thus, the image forming apparatus 2 capable of forming the given image data on a recording sheet is configured.

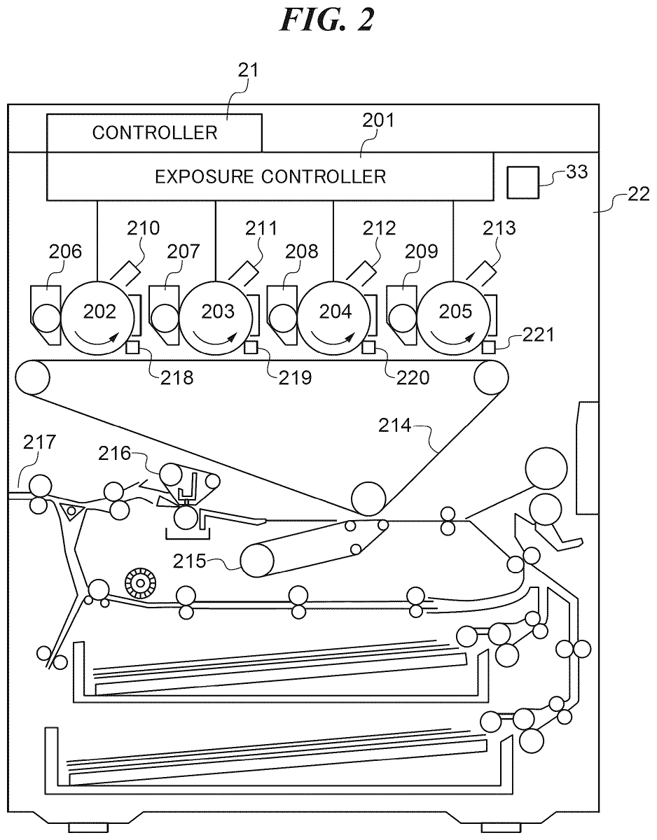

Next, the details of the image forming apparatus 2 will be described with reference to FIG. 2. The printer 22 provided with the electrophotographic print engine has a configuration as shown in FIG. 2. That is, an electrostatic latent image is formed by irradiating a charged photosensitive member (photosensitive drum) with a laser beam whose exposure intensity per unit area is modulated. Then, the electrostatic latent image is developed with developer (toner). The toner is deposited on an exposed portion and a toner image (visible image) is formed. The modulation method of the exposure intensity may be a conventional method such as PWM (Pulse Width Modulation).

The following three points are important here. (1) The exposure intensity of the laser beam for one pixel is maximized at the center of the pixel and is attenuated as the distance from the center of the pixel increases. (2) Since the exposure region (exposure spot diameter) of the laser beam for one pixel partially overlaps with the exposure region for an adjacent pixel, the final exposure intensity for a certain pixel depends on the accumulation of the exposure intensities of the adjacent pixels. (3) The toner is deposited differently depending on the final exposure intensity. For example, if the final exposure intensity for one pixel is strong over the entire region of the pixel, an image of a dark and large pixel is visualized, and if the final exposure intensity for one pixel is strong only at the center of the pixel, an image of a dark and small pixel is visualized. In the present embodiment, a dark and thick line and a dark and thick character can be printed by executing an image process described later in consideration of the above characteristics. Next, a process from receiving the print data to actually printing the image will be described.

First, photosensitive drums 202, 203, 204, and 205 as image bearing members are supported so as to be rotatable about center axes thereof, and are rotationally driven in directions shown by arrows (counterclockwise). The photosensitive drums 202 to 205 carry images formed by toners of process colors (for example, yellow, magenta, cyan, and black), respectively. Primary chargers 210, 211, 212, and 213, an exposure controller 201, and developing devices 206, 207, 208, and 209 are arranged to face the outer peripheral surfaces of the photosensitive drums 202 to 205. The primary chargers 210 to 213 charge the surfaces of the photosensitive drums 202 to 205 to a uniform negative potential (for example, −500 V).

Next, the exposure controller 201 modulates the exposure intensities of the laser beams according to the print data transmitted from the controller 21, and irradiates (exposes) the photosensitive drums 202 to 205 with the modulated laser beams. The potential of the exposed portions on the surfaces of the photosensitive drums increases to, for example, −100 V, and the portions where the potential increases form electrostatic latent images on the photosensitive drums. The toners charged to a negative developing bias potential (for example, −300 V) by the developing devices 206 to 209 are deposited to the electrostatic latent images, and toner images are formed.

The toner images are transferred from the photosensitive drums 202 to 205 to an intermediate transfer belt 214 at positions where the photosensitive drums 202 to 205 face the intermediate transfer belt 214. Then, the transferred toner images are further transferred from the intermediate transfer belt 214 to a sheet such as a paper sheet conveyed by the transfer belt 215 to a position where the intermediate transfer belt 214 faces the transfer belt 215. Then, the sheet on which the toner images are transferred is subjected to a fixing process (heating and pressing) by a fixing device 216, and is discharged from a sheet discharge port 217 to the outside of the printer 22. The above-described respective units illustrated in FIG. 2 constitute an image forming unit.

An environment sensor (a detection member) 33 detects environment information including a temperature and a water content inside the image forming apparatus 2 (inside the own device). The controller 21 is notified of the environment information obtained by the environment sensor 33 and calculates and sets a grid potential Vg. The grid potential Vg is a potential of a grid electrode of a corona charger used as the primary chargers 210, 211, 212, and 213 provided for the photosensitive drums 202 to 205, respectively. That is, the grid potential Vg is a potential of the grid electrodes of the primary chargers 210 to 213 provided for the photosensitive drums 202 to 205 and is calculated from the detected environment information. An example of a calculation method of the grid potential Vg will be described later. Surface potential sensors 218, 219, 220, and 221 measure surface potentials of the photosensitive drums 202 to 205. The surface potentials measured by the surface potential sensors 218, 219, 220, and 221 are used to adjust a contrast potential. An adjustment method of the contrast potential will be described later.

Next, the image processor 105 will be described in detail with reference to FIG. 3. As illustrated in FIG. 3, the image processor 105 includes a color converter 301, an MTF correction unit 302, the gamma correction unit 303, and the screen processor 304. The image processor 105 performs the image process for printing. The color converter 301 performs a color conversion process on image data stored in the RAM 103. For example, the color converter 301 converts the image data into a density formed of four image signals in the CMYK color space by performing a matrix operation while referring to a color conversion LUT. The color converter 301 stores the image after the color conversion in a buffer (not illustrated).

The MTF correction unit 302 receives a 3×3 (3 rows×3 columns) pixel window including a target pixel and its peripheral pixels from the buffer to perform the MTF correction process. Then, the MTF correction unit 302 performs the MTF correction using the pixel window and outputs pixel data after the MTF correction process to the gamma correction unit 303. Although the 3×3 pixel window is employed in the present embodiment, the MTF correction process may be executed using another window, such as a 5×5 pixel window or a 7×7 pixel window. The “MTF” refers to a transfer function (Modulated Transfer Function) of an optical system, and is an index indicating how faithfully a bright and dark pattern (contrast) can be reproduced in an image. The MTF correction process is for correcting the MTF deteriorated due to temporal change, environmental change, and the like.

The gamma correction unit 303 executes a gamma correction process to correct the input image data using a one-dimensional lookup table so that the image transferred to the recording sheet will have desired density characteristics. In the present embodiment, the one-dimensional lookup table having a linear characteristic is used as an example. That is, the input image data is output as is. However, the CPU 102 rewrites the one-dimensional lookup table in response to the change in the state of the printer 22. The screen processor 304 performs a screen process on the input image data and outputs the processed image data to the printer 22.

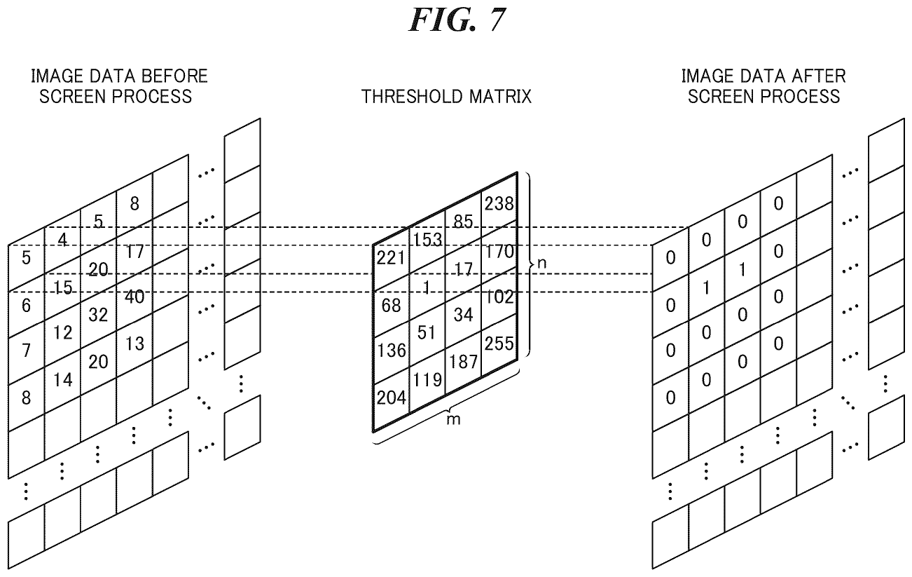

Next, the screen process performed by the screen processor 304 according to the present embodiment will be described with reference to FIG. 7. FIG. 7 is an explanatory diagram schematically illustrating a binary screen process performed by the screen processor 304.

The screen process is for converting the input image data into 1-bit image data printable by the printer 22 using a threshold matrix (see a middle matrix in FIG. 7). The threshold matrix includes “m×n” (m columns×n rows) thresholds. In the screen process, a pixel value of a pixel of the image data is compared with a threshold corresponding to the pixel read from the threshold value matrix, and “1” is output when pixel value is equal to or more than the threshold, and “0” is output in the other case. This converts multivalued image data into 1-bit image data. The threshold matrix is repeatedly applied in a tiled manner at a cycle of “m pixels” in the horizontal direction of image data and “n pixels” in the vertical direction.

For example, a 4×4 threshold matrix (m=4, n=4, 16 pixels in total) is assumed. In image data of the left matrix in FIG. 7, the corresponding 16 pixels are from the upper left pixel of which the pixel value is “5” to the lower right pixel of which the pixel value is “13”. In FIG. 7, dotted lines indicate that, as a result of comparison between the pixel value “5” (the left matrix in FIG. 7) of at the upper left pixel and the value “221” of the threshold matrix corresponding thereto, the pixel value is less than the threshold value, and therefore, the pixel value of the image data after the screen process (a right matrix in FIG. 7) becomes “0”. On the other hand, for example, in the left matrix in FIG. 7, pixel value of the pixel in the second row and the second column is “15”, and as a result of comparison with the value “1” of the threshold matrix corresponding thereto, the pixel value is more than the threshold, and thus the pixel value of the image data after the screen process becomes “1”. In this way, the image data obtained by comparing each pixel of the image data before the screen process with a set value of the threshold matrix corresponding thereto becomes the image data after the screen process (the right matrix in FIG. 7). In the present embodiment, the screen process is not limited to this, and another method may be employed as long as the method binarizes image data at a constant period.

Next, a method of correcting the contrast potential based on the environment information detected by the environment sensor 33 will be described. In the image forming apparatus with the electrophotographic system, an appropriate image density cannot be obtained unless the contrast potential is set to a value corresponding to the environment. Therefore, in the present embodiment, the contrast potential is corrected according to the amount of moisture in the image forming apparatus detected by the environment sensor 33.

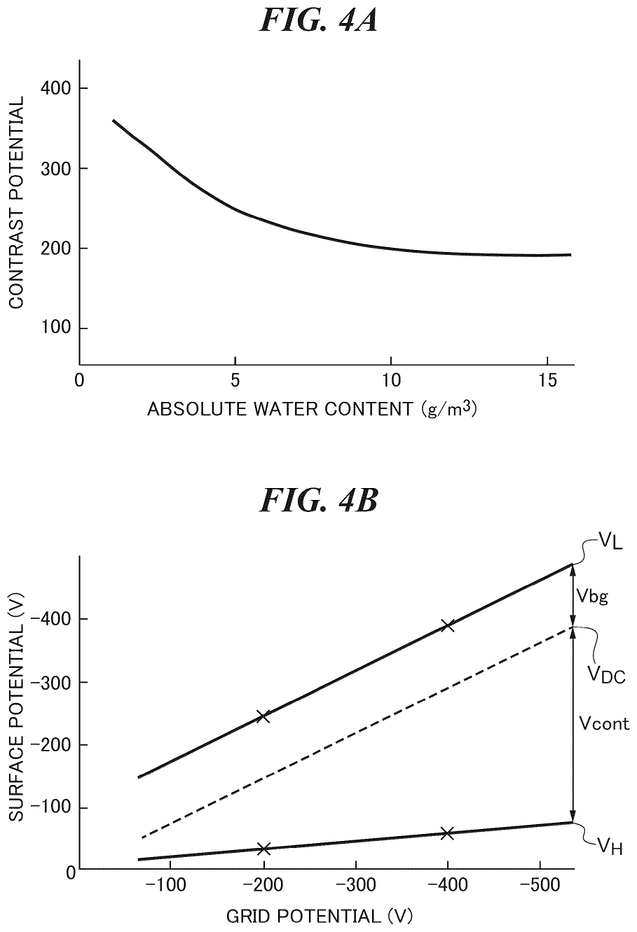

FIG. 4A indicates the relation between the contrast potential corresponding to the maximum density and the absolute water content in the image forming apparatus 2. The greater the absolute water content is, the lower the contrast potential corresponding to the maximum density is. The CPU 102 corrects the contrast potential according to the water content based on this relation. A correction coefficient Vcont.ratel to correct the contrast potential Vcont.org before correction is stored in the RAM 103. The contrast potential Vcont after the correction is calculated by the following equation (1)

Vcont=Vcont.org·Vcont.ratel (1)

The printer 22 detects the transition of the environment (water content) every 30 minutes with the environment sensor 33 and calculates the contrast potential Vcont by “Vcont.org. Vcont.ratel” using the equation (1) every time the contrast potential is corrected based on the result. The CPU 102 sets the grid potential Vg and the developing bias potential VDC so as to obtain such a contrast potential Vcont.

Next, a method of obtaining the grid potential and the developing bias potential from the corrected contrast potential Vcont will be briefly described. FIG. 4B is a graph illustrating a relation between the grid potential and the surface potential of the photosensitive drums 202, 203, 204, and 205. As described above, the grid potential is the potential of the grid electrode of the corona charger used as the primary chargers 210, 211, 212, and 213. The developing bias potential is the potential of the developing devices 206, 207, 208, and 209.

First, the grid potential is set to −200 V, and the surface potential described below is measured. That is, a low surface potential VL, which is the surface potential of the photosensitive drums 202, 203, 204, and 205 exposed to the laser light modulated with the minimum signal value, is measured by the surface potential sensors 218, 219, 220, and 221. Further, a high surface potential VH, which is the surface potential of the photosensitive drums 202, 203, 204, and 205 exposed to the laser light modulated with the maximum signal value, is measured by the surface potential sensors 218, 219, 220, and 221. Similarly, the grid potential is set to −400 V, and the low surface potential VL and the high surface potential VH are measured. These measurement results are indicated by cross marks in FIG. 4B. Then, the relation between the grid potential and the surface potential is obtained by interpolating and extrapolating data using the surface potentials in −200 V and −400 V. The control for obtaining the potential data is referred to as potential measurement control.

Next, the developing bias potential VDC that is higher than the low surface potential VL by a potential difference Vbg (for example, 100V) set so as not to cause toner fogging in an image is set. The contrast potential Vcont is a differential voltage between the developing bias potential VDC and the high surface potential VH, and the maximum density increases as the contrast potential Vcont increases. The grid potential Vg and the developing bias potential VDC to obtain the calculated contrast potential Vcont can be obtained from the relation illustrated in FIG. 4B. Therefore, the CPU 102 finds the contrast potential Vcont at which the maximum density is higher than the final target value by, for example, about 0.1 V, and determines the grid potential Vg and the developing bias potential VDC so as to obtain the contrast potential Vcont. As described above, the grid potential Vg is calculated from the environment information.

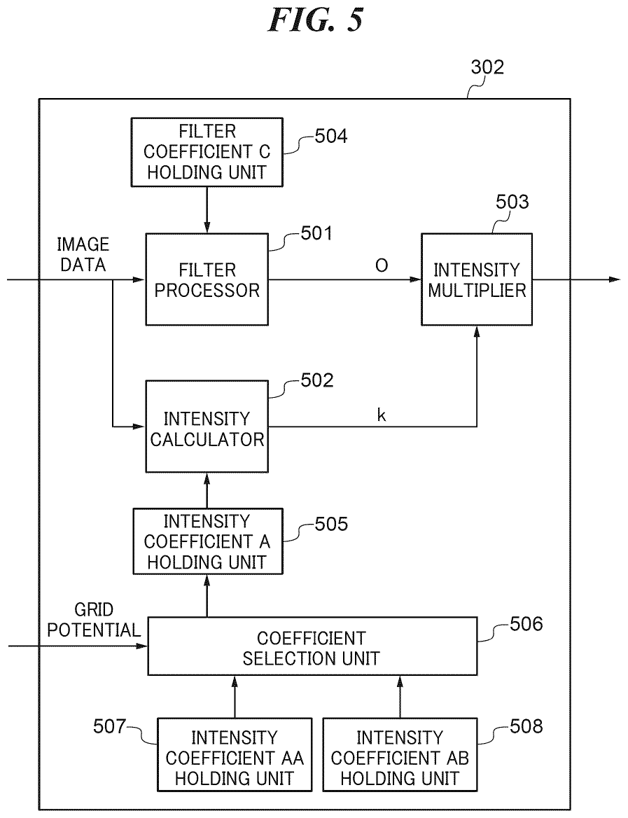

Next, a configuration of the MTF correction unit 302 in FIG. 3 will be described. FIG. 5 is a block diagram illustrating the MTF correction unit 302. The MTF correction unit 302 includes a filter processor 501, an intensity calculator 502, an intensity multiplier 503, a filter coefficient C holding unit 504, an intensity coefficient A holding unit 505, a coefficient selection unit 506, an intensity coefficient AA holding unit 507, and an intensity coefficient AB holding unit 508.

The filter processor 501 multiplies the pixel values of the target pixel and its peripheral pixels by a filter coefficient C. Specifically, the filter processing result O(i, j) is obtained by applying a filter coefficient C to the pixel value D according to the following equation (2). Here, (i, j) indicates the coordinate in the image. Further, (x, y) indicates the coordinate in the filter. A constant W is determined by the magnitude of the filter coefficient C, and the constant W is “1” in the present embodiment.

$$O ( i , j ) = {\sum }_{x = W}^{W} {\sum }_{y = W}^{W} D ( i + x , j + y ) \cdot C ( x , y ) \qquad ( 2 )$$

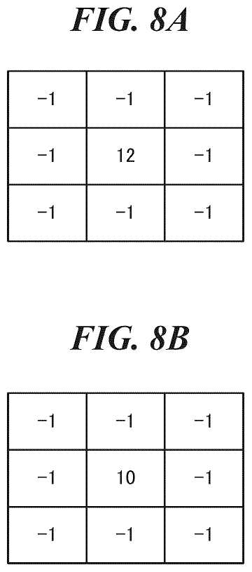

FIG. 8A and FIG. 8B are views describing examples of the filter coefficients C (Sobel filter) used in the present embodiment. Each of the filters are a 3×3 matrix and a value at the center position is positive and values around the center position are negative. These are merely examples.

The intensity calculator 502 calculates an intensity amount k from the target pixel value with reference to a one-dimensional lookup table. The intensity multiplier 503 determines and outputs an output pixel value based on the filter result O output by the filter processor 501 and the intensity amount k output by the intensity calculator 502. Specifically, the filter result O output by the filter processor 501 and the intensity amount k output by the intensity calculator 502 are multiplied. The filter coefficient C holding unit 504 holds the filter coefficient C that is applied to the filter processor 501. The MTF correction unit 302 (a correction unit for frequency characteristics) can be implemented by correcting frequency characteristics of image data (an inputted image) using the filter coefficient C held by the filter coefficient C holding unit 504 and the correction coefficient A of the correction intensity held by the coefficient intensity A holding unit 505.

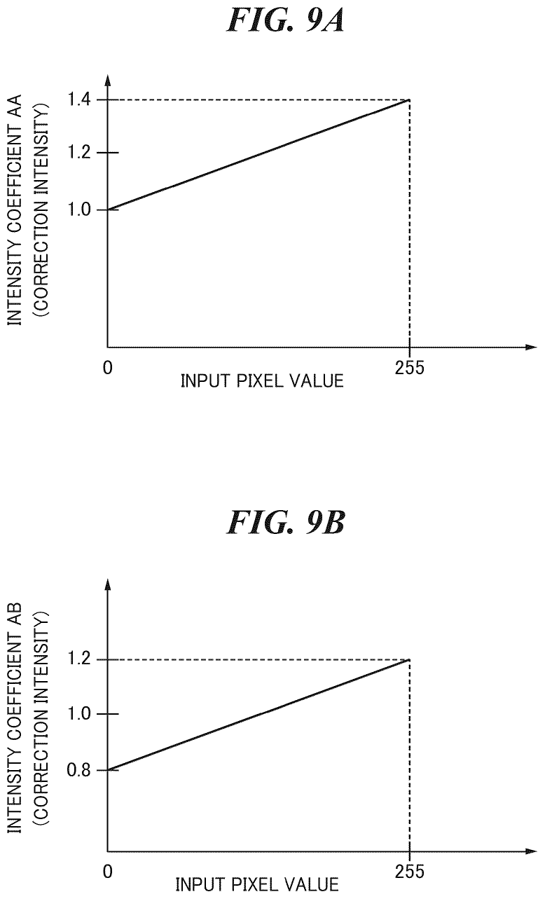

The intensity coefficient A holding unit 505 holds a one dimensional lookup table used by the intensity calculator 502. The coefficient selection unit 506 selects an intensity coefficient to be set as the intensity coefficient A holding unit 505 according to the grid potential Vg. The intensity coefficient AA holding unit 507 holds an intensity coefficient AA that is set when the grid potential Vg is less than a threshold Vth. In the present embodiment, as an example, the threshold Vth shall be −450 V. FIG. 9A is a graph illustrating an example of a one-dimensional lookup table of the intensity coefficient AA (correction intensity) according to the present embodiment.

The intensity coefficient AB holding unit 508 holds an intensity coefficient AB that is set when the grid potential Vg is equal to or more than the threshold Vth. FIG. 9B is a graph illustrating an example of a one-dimensional lookup table of the intensity coefficient AB (correction intensity) according to the present embodiment. Since the amount of image blur increases as the grid potential Vg decreases, the correction intensity in FIG. 9A is larger than that in FIG. 9B. That is, the correction intensity to the corresponding input pixel value on the straight line indicating the relation between the input pixel value and the correction intensity is larger in FIG. 9A. Although the correction intensity is calculated by comparing the grid potential Vg with the threshold value Vth in the present embodiment, a method of calculating the correction intensity by linear interpolation from the information about two or more correction intensities information and the grid potential Vg may be used. In this way, the lookup tables shown in FIG. 9A and FIG. 9B associate the input pixel value with the correction intensity (intensity coefficient). When the input pixel value is given, the corresponding intensity coefficients AA and AB are obtained by using the lookup tables. Thus, the correction of the frequency characteristics in the entire MTF correction unit 302 can be achieved by correcting the intensity coefficient A (correction intensity) held by the intensity coefficient A holding unit 505 using the obtained intensity coefficient AA or AB.

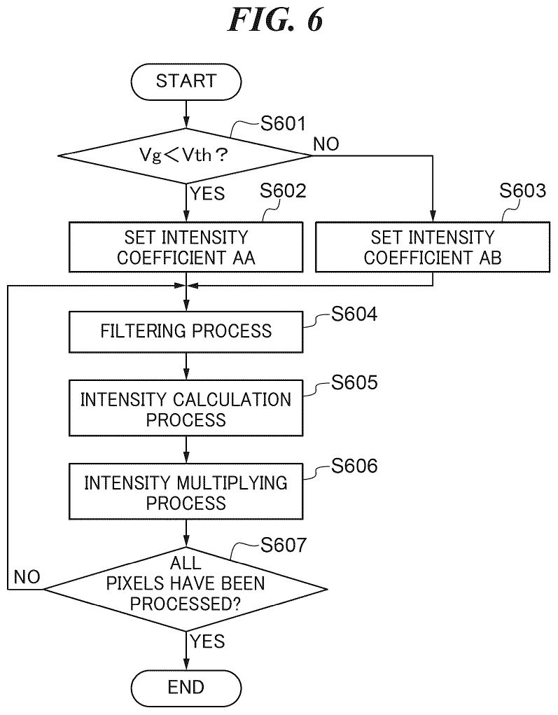

FIG. 6 is a flowchart illustrating the MTF correction process executed by the MTF correction unit 302. First, in a step S601, the coefficient selection unit 506 determines a coefficient to be set as the intensity coefficient A based on the obtained grid potential Vg. Specifically, when it is determined that the grid potential Vg is less than the preset threshold Vth (YES), the process proceeds to a step S602. When it is determined that the grid potential Vg is equal to or more than the preset threshold Vth (NO), the process proceeds to a step S603.

In the step S602, the coefficient selection unit 506 sets the intensity coefficient AA as the intensity coefficient A. On the other hand, in the step S603, the coefficient selection unit 506 sets the intensity coefficient AB as the intensity coefficient A. That is, the coefficient selection unit 506 selects the intensity coefficient AA (first correction intensity) to correct the intensity coefficient A (correction coefficient) when the grid potential Vg is less than the threshold Vth. On the other hand, in other cases, the coefficient selection unit 506 selects the intensity coefficient AB (second correction intensity) and corrects the intensity coefficient A (correction coefficient). Further, the intensity coefficient A may be corrected by any one of three or more intensity coefficients according to the grid potential Vg.

In the next step S604, the filter processor 501 obtains the filter coefficient C from the filter coefficient C holding unit 504, performs the filter process on the target pixel and its peripheral pixels, and outputs the obtained filter result O (i, j) to the intensity multiplier 503. Here, (i, j) is a coordinate in the image.

In the next step S605, the intensity calculator 502 performs an intensity calculation process, that is, calculates the intensity amount k based on the target pixel value D(i, j) as an input by referring to the intensity coefficient A using the one-dimensional lookup table (see FIG. 9A and FIG. 9B). In the next step S606, the intensity multiplier 503 performs an intensity multiplying process, that is, determines and outputs the output pixel value OUT based on the filter result O output by the filter processor 501 and the intensity amount k output by the intensity calculator 502. Specifically, the calculation is performed by the following equation (3). Here, (i, j) indicates the coordinate in the image.

$$OUT ( i , j ) = O ( i , j ) \cdot k ( i , j ) \qquad ( 3 )$$

Then, in a step S607, the MTF correction unit 302 determines whether the MTF correction process has been executed for all the pixels of the given image data. When it is determined that the process has not been executed for all the pixels (NO), the process returns to the step S604. On the other hand, when it is determined that the process has been executed for all the pixels (YES), the MTF correction unit 302 ends the MTF correction process in FIG. 6. Although the coefficient selection unit 506 determines the coefficient to be set in the intensity coefficient A holding unit 505 based on the grid potential Vg in the present embodiment, the CPU 102 may determine the coefficient by executing a program stored in the ROM 104.

As described above, in the first embodiment, the grid potential Vg is calculated and set from the environment information detected by the environment sensor 33, and the appropriate correction intensity is calculated from the potential setting. Therefore, the MTF correction intensity can be adjusted according to the change in characteristics of the photosensitive member. Thus, even if the characteristics of the photosensitive member change due to temporal change or environmental change, the image deterioration can be prevented by performing the appropriate correction process.

Hereinafter, an image process (a correction process) according to a second embodiment of the present disclosure will be described. In the first embodiment, the method of adjusting the correction intensity of the MTF correction process based on the environment information has been described. However, it is known that a latent image potential varies depending on a screen ruling (the number of lines in a screen process), and a blur amount of an image varies if the latent image potential varies depending on the screen ruling. Therefore, it is desirable to adjust the correction intensity of the MTF correction process based on the screen ruling. The present embodiment is characterized in that the correction amount is determined based on the screen ruling. Note that the following description will be made basically on the differences from the first embodiment.

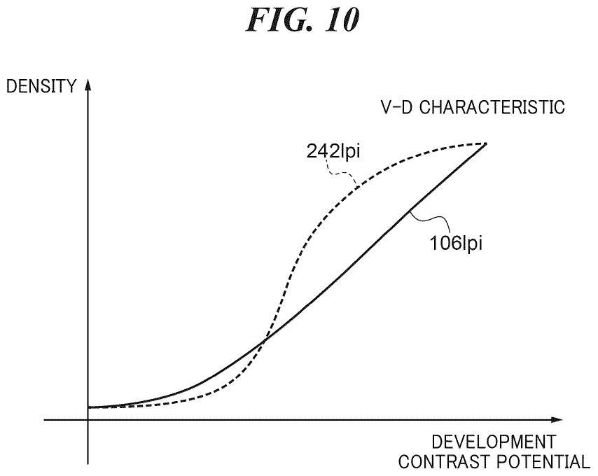

First, the relation between the screen ruling and the state of the latent image will be described. FIG. 10 is a graph illustrating V-D characteristics representing relations between development contrast potential Vcont (difference between the development bias potential and the high surface potential: see FIG. 4B) and the density. Here, a screen process with a high screen ruling of 242 lpi having a relatively fine dot definition and a screen process with a low screen ruling of 106 lpi having a relatively coarse dot definition are compared. The “lpi” is a shorted form of “liens per inch” and a unit of screen ruling (resolution) of a printed matter. The V-D characteristic of 106 lpi draws a clear curve that is convex downward.

On the other hand, the V-D characteristic of 242 lpi is less likely to appear the density in a high light area. Further, the V-D characteristic rapidly changes the density by the screen process and shows what is called an S-shaped curve characteristic in which the density is not changed in a shadow area. When the photosensitive drums 202, 203, 204, and 205 change with time or the output of the light source of the exposure controller 201 changes, the density likely changes. This is because the output density does not have a linear relation with the development contrast potential Vcont determined using a solid image having a uniform density, and often draws an S-shaped curve. Furthermore, this phenomenon depends on whether the dot contrast in the latent image is sufficiently secured. However, in the following, in order to describe the density variation due to the fineness of the dots, the latent image when the dots are formed will be described.

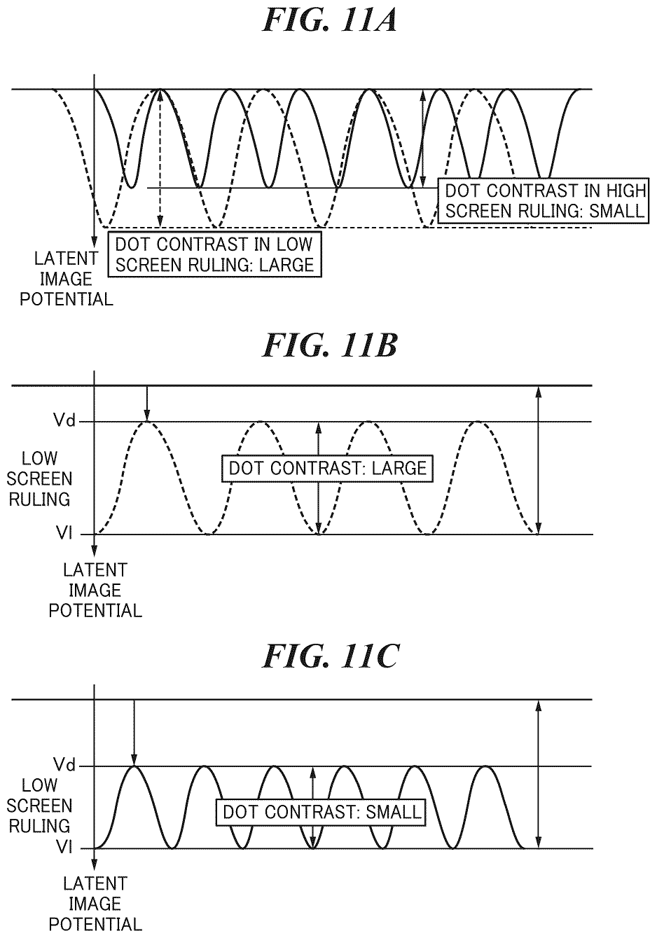

FIG. 11A is a graph illustrating the latent image potential in the high light area to which the screen process is applied. Further, FIG. 11B is a graph illustrating the latent image potential in the screen area to which the screen process of the low screen ruling is applied. FIG. 11C is a graph illustrating the latent image potential in the screen area to which the screen process of the high screen ruling is applied. As illustrated in FIG. 11A, it is difficult to increase the latent image potential in the high light area. This is because the number of pixels per dot decreases and the value of the dot contrast decreases as the screen ruling increases. On the other hand, in the screen process of the low screen ruling, the value of the dot contrast can be increased. This is because the number of pixels per dot is large.

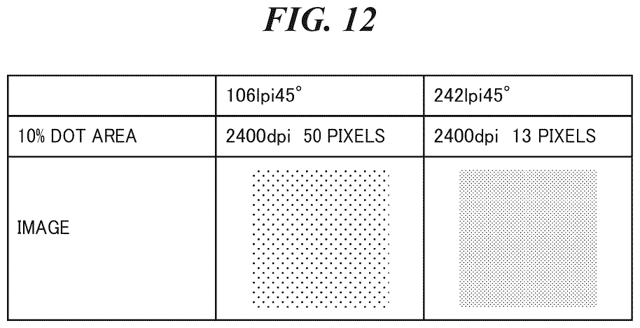

FIG. 12 is a view explanatory illustrating a difference in a dot size depending on a difference in the screen ruling. FIG. 12 illustrates an example of an image to which screen process with a relatively high screen ruling is applied and an example of an image to which screen process with a relatively low screen ruling applied. The number of dot pixels (10 dot area) for 2400 dpi and 106 lpi is 50 pixels. On the other hand, the number of dot pixels for 2400 dpi and 242 lpi is 13 pixels. As can be seen from an IMAGE row in FIG. 12, the dot interval is relatively narrow in 2400 dpi and 242 lpi. As described above, since the dots of the screen process of 106 lpi are larger than the dots of the screen process of 242 lpi, the latent image potential is stable, and even if the characteristics of the printer 22 are slightly changed, the influence thereof is hardly received.

As illustrated in FIG. 11B and FIG. 11C, in the screen process, a dark potential Vd (referred to as an inter-dot dark potential) existing between adjacent dots is lowered. However, a bright potential Vl is maintained. Therefore, as can be seen from the comparison between FIG. 11B and FIG. 11C, the dot contrast of the screen process with the high screen ruling is smaller than the dot contrast of the screen process with the low screen ruling. Although the density gradation should be expressed by the area gradation (dot area) faithful to image data, a sharp dot latent image is not formed because the inter-dot dark potential is lowered.

Since the density starts to increase between dots when the latent image potential exceeds a certain threshold (developing bias potential), the density gradient changes rapidly. Due to such a phenomenon, the characteristic for the high screen ruling draws the S-shaped curve, and the characteristic for the low screen ruling draws the clear curve that is convex downward (see FIG. 10). As described above, even if the characteristics of the printer 22 are the same, the latent image potential characteristic varies depending on the dot definition.

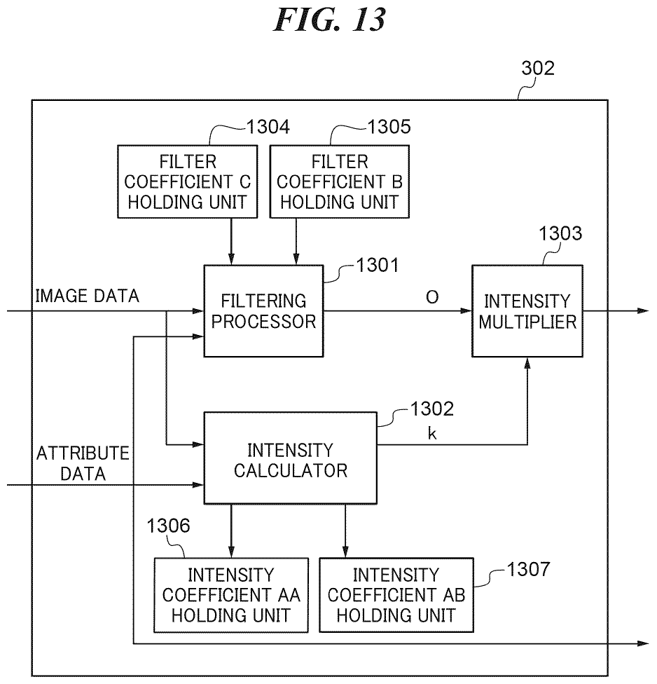

Next, a configuration of the MTF correction unit 302 in the second embodiment will be described. FIG. 13 is a block diagram illustrating the MTF correction unit 302 in the second embodiment. The MTF correction unit 302 includes a filter processor 1301, an intensity calculator 1302, an intensity multiplier 1303, a filter coefficient C holding unit 1304, a filter coefficient B holding unit 1305, an intensity coefficient AA holding unit 1306, and an intensity coefficient AB holding unit 1307. The filter processor 1301, the intensity calculator 1302, and the intensity multiplier 1303 have the same configurations as the filter processor 501, the intensity calculator 502, and the intensity multiplier 503 in FIG. 5.

The filter processor 1301 receives image data and attribute data, obtains filter coefficient C or B from the filter coefficient C holding unit 1304 or the filter coefficient B holding unit 1305, and multiplies the pixel values of the target pixel and its peripheral pixels by the coefficient C or B. The intensity calculator 1302 receives the image data and the attribute data, and calculates the intensity amount k from the target pixel value with reference to the one-dimensional lookup table (FIG. 9A or FIG. 9B). The intensity multiplier 1303 determines and outputs an output pixel value based on the filter result O output by the filter processor 1301 and the intensity amount k output by the intensity calculator 1302.

The filter coefficient C holding unit 1304 and the filter coefficient B holding unit 1305 hold the different filter coefficients C and B that are applied by the filter processor 1301. The intensity coefficient AA holding unit 1306 and the intensity coefficient AB holding unit 1307 hold the different one-dimensional lookup tables used by the intensity calculator 1302 (see FIG. 9A and FIG. 9B).

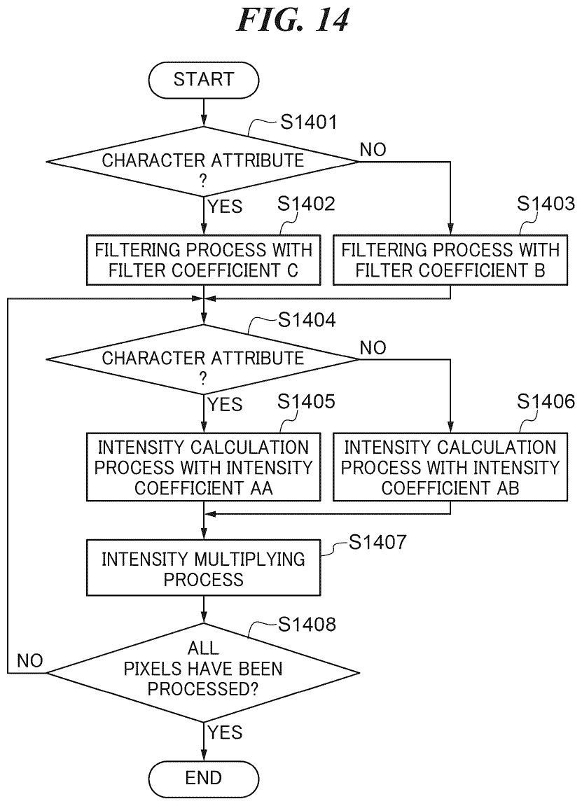

FIG. 14 is a flowchart illustrating an MTF correction process performed by the MTF correction unit 302 of the second embodiment.

First, in a step S1401, the filter processor 1301 determines whether the attribute of the target pixel is the character attribute. When it is determined that the attributes is the character attribute (YES), the process proceeds to a step S1402. When it is determined that the attribute is not the character attribute (NO), the process proceeds to a step S1403. This is because the screen process with a relatively high screen ruling is applied to a pixel of the character attribute, whereas the screen process with a relatively low screen ruling is applied to a pixel of the attribute other than the character attribute and thus it is necessary to execute another process. That is, since the blur amount is different for each pixel, the attribute is determined and the correction amount is adjusted in accordance with the attribute, thereby performing correction of an appropriate amount.

In the step S1402, the filter processor 1301 obtains the filter coefficient C from the filter coefficient C holding unit 1304, performs the filter process on the target pixel and its peripheral pixels, and outputs the filter result O (i, j) to the intensity multiplier 1303. The Sobel filter in FIG. 8A is an example of the filter coefficient C.

On the other hand, in the step S1403, the filter processor 1301 obtains the filter coefficient B from the filter coefficient B holding unit 1305, performs the filter process on the target pixel and its peripheral pixels, and outputs the filter result O (i, j) to the intensity multiplier 1303. The Sobel filter in FIG. 8B is an example of the filter coefficient B. The screen with high screen ruling applied to a character has a shorter distance between dots, is more likely to be strongly affected by latent images of adjacent dots, and has a larger image blur amount. Therefore, it is understood that the filter coefficient C shown in FIG. 8A applied to the character portion has a stronger intensity than the filter coefficient B shown in FIG. 8B. This is understood from the fact that the Sobel filter shown in FIG. 8B has a smaller center value “10” and the negative values around the center value are the same value “−1”.

In the next step S1404, the intensity calculator 1302 determines whether the attribute of the target pixel is the character attribute. When it is determined that the attributes is the character attribute (YES), the process proceeds to a step S1405. When it is determined that the attribute is not the character attribute (NO), the process proceeds to a step S1406.

In the step S1405, the intensity calculator 1302 performs an intensity calculation process, that is, calculates the intensity amount k based on the target pixel value D(i, j) as an input by referring to the intensity coefficient AA that is a one-dimensional lookup table. FIG. 9A is an example of the intensity coefficient AA, and the correction intensity defined by a straight line with respect to the input pixel value becomes the one-dimensional lookup table used by the intensity calculator 1302.

On the other hand, in the step S1406, the intensity calculator 1302 performs the intensity calculation process, that is, calculates the intensity amount k based on the target pixel value D(i, j) as an input by referring to the intensity coefficient AB that is a one-dimensional lookup table. FIG. 9B is an example of the intensity coefficient AB, and the correction intensity defined by a straight line with respect to the input pixel value becomes the one-dimensional lookup table used by the intensity calculator 1302. The distance between dots is shorter in the screen with high screen ruling applied to a character. In addition, since the screen with high screen ruling applied to a character is more likely to be strongly affected by latent images of adjacent dots, an image blur amount becomes larger. Therefore, it is understood that the intensity coefficient AA shown in FIG. 9A applied to the character portion has higher intensity than the intensity coefficient AB shown in FIG. 9B applied to a portion other than a character. By comparing FIG. 9A and FIG. 9B, it is understood that a value of the correction intensity corresponding to a certain input pixel value in FIG. 9A is larger than a value of the correction intensity corresponding the same input pixel value.

That is, the intensity calculator 1302 selects (corrects) the intensity amount k (first correction intensity) with reference to the intensity coefficient AA when the attribute data of the target pixel is the character attribute. On the other hand, in other cases, the intensity amount k (second correction intensity) with reference to the intensity coefficient AB is selected (corrected).

In the next step S1407, the intensity multiplier 1303 determines and outputs a pixel value based on the filter result O output by the filter processor 1301 and the intensity amount k output by the intensity calculator 1302. Specifically, the intensity multiplier 1303 performs the calculation using the above equation (3). Then, in a step S1408, the MTF correction unit 302 determines whether the process has been executed for all the pixels of the given image data. When it is determined that the process has not been executed for all the pixels (NO), the process returns to the step S1404. On the other hand, when the MTF correction unit 302 determines that the process has been executed for all the pixels (YES), the MTF correction unit 302 ends the MTF correction process.

As can be seen from the steps S1401 to S1406 in FIG. 14, when the filter coefficient C is used, the intensity amount k held by the intensity coefficient AA is used, and when the filter coefficient B is used, the intensity amount k held by the intensity coefficient AB is used.

As described above, in the second embodiment, it is possible to perform the appropriate correction by switching the filter coefficient and the intensity coefficient of the MTF process according to the attribute information with respect to the image blur that changes in accordance with the screen ruling of the screen to be applied. Although the intensity is switched depending on the screen ruling in this embodiment, the intensity coefficient may be switched correspondingly to each of the photosensitive drums 202, 203, 204 and 205.

Hereinafter, an image process according to a third embodiment of the present disclosure will be described. In the second embodiment, the method of adjusting the correction intensity of the MTF correction process on the basis of the screen ruling information of the screen process has been described. However, since preference for a sharpness intensity indicating a sharpness of an image is different for each user, it is desirable that the sharpness intensity can be selection according to the preference of the user. In the present embodiment, a method of adjusting the correction intensity of the MTF correction process according to the preference of the user will be described. Note that the following description will be made basically on the differences from the first embodiment.

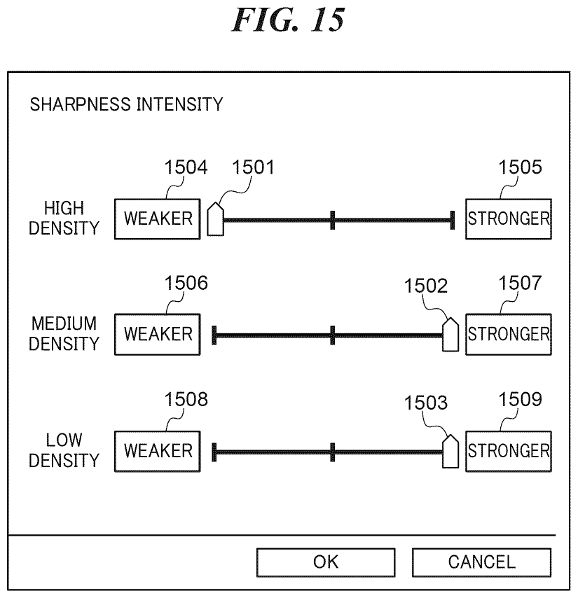

The operation unit 108 illustrated in FIG. 1 is the user interface having the touch screen and receives a setting instruction about the process in the MTF correction unit 302 from the user. For example, the operation unit 108 displays a setting screen as illustrated in FIG. 15 and receives a user's setting operation related to the MTF correction process performed by the MTF correction unit 302.

A method of setting the density information related to the MTF correction process will be described with reference to FIG. 15. FIG. 15 shows an example in which the sharpness intensity indicating the sharpness of the image can be changed by a user's setting operation. The correction intensity can be set and changed among three steps for each density range (high density, medium density, and low density). For example, when a button 1504 is pressed, the correction intensity in the high density range is weakened, and when a button 1505 is pressed, the correction intensity in the high density range is strengthened. Similarly, when a button 1506 is pressed, the correction intensity in the middle density range is weakened, and when a button 1507 is pressed, the correction intensity in the middle density range is strengthened. When a button 1508 is pressed, the correction intensity in the low density range is weakened, and when a button 1509 is pressed, the correction intensity in the low density range is strengthened.

Note that a state in which each of marks 1501, 1502, and 1503 is set to an intermediate position between WEAKER and STRONGER corresponds to a state in which the sharpness intensity is adjusted to middle between weak and strong. That is, the positions of the marks 1501, 1502, and 1503 indicate the intensities in the respective density ranges each of which can be selected from among the three steps.

Then, the CPU 102 moves the marks 1501, 1502, and 1503 in the horizontal direction in response to the press operations of the buttons 1504 to 1509. For example, the CPU 102 moves the mark 1501 leftward in response to the press operation of the button 1504, and moves the mark 1501 rightward in response to the press operation of the button 1505. FIG. 15 shows a state where the mark 1501 is moved to the full left (weak) and the correction intensity in the high density range is set to weak. The CPU 102 moves the other marks 1502 and 1503 in the same manner in accordance with the press operations of the buttons 1506 to 1509 in the middle and low density ranges. The adjusted sharpness density settings are indicated by the marks 1501, 1502, and 1503, and thus the user can be visually confirmed.

When an OK button is touched, the CPU 102 stores these settings in the RAM 103. When a CANCEL button is touched, the CPU 102 cancels the change of the settings by the user. The MTF correction unit 302 of the image processor 105 executes the correction process reflecting the stored settings.

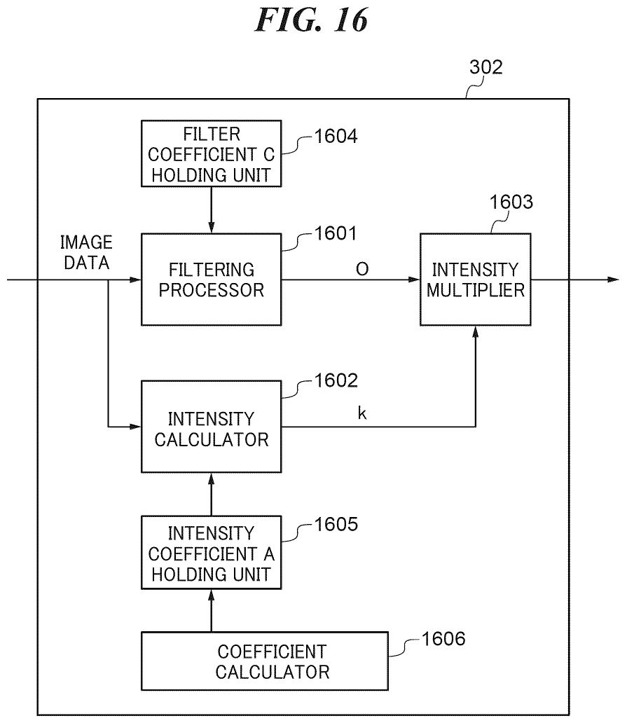

Next, a configuration of the MTF correction unit 302 in the third embodiment will be described. FIG. 16 is a block diagram illustrating the MTF correction unit related to the third embodiment. The MTF correction unit 302 includes a filter processor 1601, an intensity calculator 1602, an intensity multiplier 1603, a filter coefficient C holding unit 1604, an intensity coefficient A holding unit 1605, and a coefficient calculator 1606. The coefficient calculator 1606 calculates the intensity coefficient based on the set value of the correction intensity for each density range designated by the user. The calculation method will be described later. The filter processor 1601, the intensity calculator 1602, the intensity multiplier 1603, the filter coefficient C holding unit 1604, and the intensity coefficient A holding unit 1605 have the same configurations as the filter processor 501, the intensity calculator 502, the intensity multiplier 503, the filter coefficient C holding unit 504, and the intensity coefficient A holding unit 505 in FIG. 5.

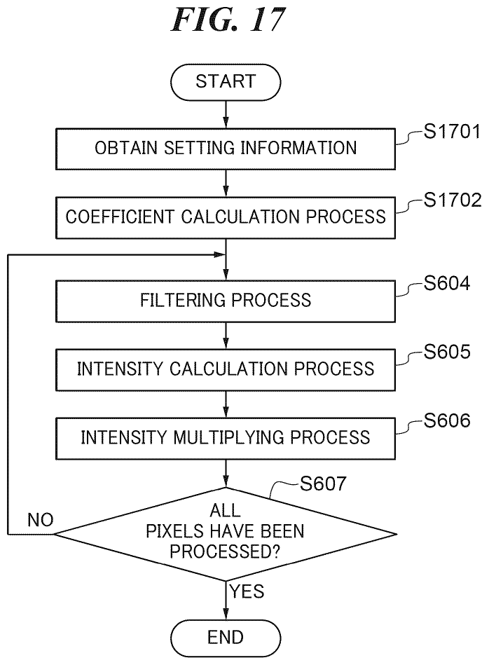

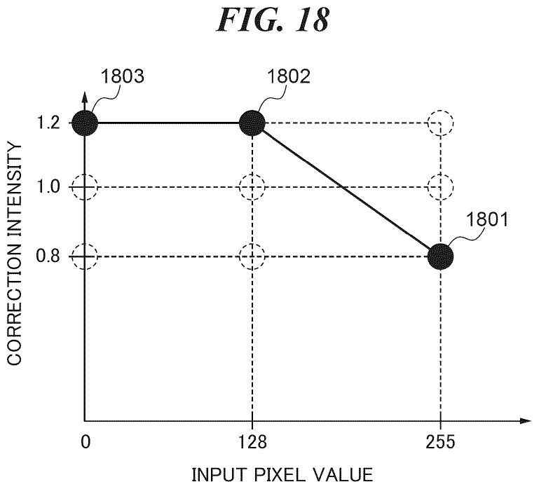

An MTF correction process according to the third embodiment will be described with reference to FIG. 17 and FIG. 18. FIG. 17 is a flowchart illustrating the MTF correction process performed by the MTF correction unit 302 related to the third embodiment. FIG. 18 is a view describing a coefficient calculation process. First, in a step S1701, the coefficient calculator 1606 obtains the setting information (adjustment information) about the correction intensity for each density range set by the user's setting operation using the operation unit 108.

In the next step S1702, the coefficient calculator 1606 performs the coefficient calculation process based on the obtained set value of the correction intensity for each density range to calculate the intensity coefficient, and sets the intensity coefficient to the intensity coefficient A holding unit 1605. Here, the coefficient calculation process will be described with reference to FIG. 15. The operation unit 108 refers to the position of the mark 1501 and notifies the coefficient calculator 1606 of the coefficient information indicating “weak” as the correction intensity value in the high density range. Further, the operation unit 108 refers to the position of the mark 1502 and notifies the coefficient calculator 1606 of the coefficient information indicating “strong” as the correction intensity value in the middle density range. Still further, the operation unit 108 refers to the position of the mark 1503 and notifies the coefficient calculator 1606 of the coefficient information indicating “strong” as the correction intensity value in the low density range.

As illustrated in FIG. 18, the coefficient calculator 1606 plots a point 1801 corresponding to “weak” in the high density range, a point 1802 corresponding to “strong” in the medium density range, and a point 1803 corresponding to “strong” in the low density range, and transmits the relation between these input pixel values and the correction intensities to the intensity coefficient A holding unit 1605. Accordingly, the intensity coefficient A holding unit 1605 can hold the one-dimensional lookup table (see FIG. 9A and FIG. 9B) used by the intensity calculator 1602. In the density ranges between “0”, “128”, and “255” of the input pixel value, the correction intensity may be calculated by linear interpolation, and the intensity coefficient may be calculated and set as shown in FIG. 18. Since the steps S604 to S607, which are the subsequent steps in FIG. 17, are as described in FIG. 6, the duplicated description will be omitted.

As described above, according to the third embodiment, the coefficient calculator 1606 obtains the information related to the strength setting of the sharpening strength (sharpness strength) of the image set by the operation using the operation unit 108 provided in the image forming apparatus 2. Then, the MTF correction unit 302 receives the correction intensity from the UI and calculates the intensity coefficient, and thus it is possible to adjust the correction intensity according to the preference of the user.

The image forming apparatus 2 is capable of forming image data given from the host computer 1 on a recording sheet, and the MTF correction unit 302 corrects the frequency characteristic of the image data with the first correction coefficient. The CPU 102 calculates the first correction coefficient by correcting the second correction coefficient based on the correction information for correcting the second correction coefficient (the intensity coefficient AA or AB) contributing to the first correction process. Since the MTF correction unit 302 performs the MTF correction process with the calculated new first correction coefficient even if the deterioration amount of the MTF changes, the first correction coefficient and the correction intensity contributing to the first correction coefficient are switched, and thus it is possible to suppress the image deterioration.

According to the present disclosure, the execution of the appropriate correction process cases an effect that does not deteriorate an image even if the image blur amount varies due to various factors such as temporal change and environmental change.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-002370, filed Jan. 7, 2025 which is hereby incorporated by reference herein in its entirety.

What is claimed is:

1. An image forming apparatus capable of forming, on a sheet, an image based on image data, the image forming apparatus comprising:
a memory device that stores a set of instructions; and
at least one processor that executes the set of instructions to:
determine correction coefficient based on a grid potential of a grid electrode of a charger provided for a photosensitive drum of the image forming apparatus; and
execute a correction process of a frequency characteristic of the image data based on the determined correction coefficient.

2. The image forming apparatus according to claim 1, wherein the grid potential is calculated from environment information.

3. The image forming apparatus according to claim 2, further comprising a detection member to detect the environment information.

4. The image forming apparatus according to claim 3, wherein the at least one processor executes instructions in the memory device to correct the correction coefficient according to a result of comparison between a preset threshold and the grid potential.

5. The image forming apparatus according to claim 4, wherein the at least one processor executes instructions in the memory device to:
select a first correction intensity in a case where the grid potential is less than the threshold,
select a second correction intensity in a case where the grid potential is equal to or more than the threshold, and
correct the second correction coefficient using selected one of the first correction intensity and the second correction intensity.

6. The image forming apparatus according to claim 1, wherein the at least one processor executes instructions in the memory device to obtain an attribute of a pixel of an input image.

7. The image forming apparatus according to claim 6, wherein the at least one processor executes instructions in the memory device to:
execute a screen process, which binarizes the image data after the correction process, with a relatively high screen ruling in a case where the attribute of the pixel is a character attribute;
execute the screen process with a relatively low screen ruling in a case where the attribute of the pixel is not the character attribute.

8. The image forming apparatus according to claim 1, where the at least one processor executes instructions in the memory device to obtain information related to a strength setting of sharpening strength of the image, which is set by an operation using an operation unit provided in the image forming apparatus.

9. The image forming apparatus according to claim 1, wherein the correction process is an MTF correction process.

10. A control method for an image forming apparatus capable of forming, on a sheet, an image based on image data, the control method comprising:
determining correction coefficient based on a grid potential of a grid electrode of a charger provided for a photosensitive drum of the image forming apparatus; and
executing a correction process of a frequency characteristic of the image data based on the determined correction coefficient.

11. A non-transitory computer-readable storage medium storing a control program causing a computer to execute a control method for an image forming apparatus capable of forming, on a sheet, an image based on image data, the control method comprising:
determining correction coefficient based on a grid potential of a grid electrode of a charger provided for a photosensitive drum of the image forming apparatus; and
executing a correction process of a frequency characteristic of the image data based on the determined correction coefficient.
